(19) United States
(12) Patent Application Publication
(10) Pub. No.: US 2014/0039127 A1
(43) Pub. Date: Feb. 6, 2014

(54) POLYETHER ETHER KETONE COMPOSITE MATERIAL

(71) Applicant: Olympus Corporation, Tokyo (JP)

(72) Inventor: TAKESHI KIDA, Tokyo (JP)

(73) Assignee: Olympus Corporation, Tokyo (JP)

(21) Appl. No.: 14/051,978

(22) Filed: Oct. 11, 2013

Related U.S. Application Data
(63) Continuation-in-part of application No. PCT/JP2012/068681, filed on Jul. 24, 2012.

(30) Foreign Application Priority Data
Jul. 25, 2011 (JP) 2011-162085

(51) Int. Cl. C08L 61/16; C08L 23/12

(52) U.S. Cl. CPC C08L 61/16; C08L 23/12
USPC 525/132

(57) ABSTRACT

A polyether ether ketone composite material of the present invention includes PEEK and polyolefin, in which the composite material has a single endothermic peak in a DSC. The PEEK and the polyolefin are preferably to have compatibility with each other, and the composite material may have a matrix part formed from the PEEK and a first dispersed part formed from the polyolefin having a particle size of 1 μm or smaller. The composite material may have a matrix part formed from the PEEK and a second dispersed part dispersed in the matrix part, and the second dispersed part may be formed from the PEEK and the polyolefin, a dispersion PEEK is dispersed in the polyolefin, and the second dispersed part has a particle size of 10 μm or smaller.

### BACKGROUND ART

1. Field of the Invention

The present invention relates to a polyether ether ketone composite material.

The present invention claims the priority based on Japanese Patent Application No. 2011-162085, filed on Jul. 25, 2011, is a continuation-in-part application of PCT International Application No. PCT/JP2012/068681, filed on Jul. 24, 2012, the entire contents of which are incorporated herein by reference.

2. Related Art

Polyether ether ketone (hereinafter, referred to as “PEEK” in some cases) is a kind of a so-called super engineering plastic, and has properties of high fatigue strength, heat resistance, chemical resistance and the like. A composite material containing PEEK (hereinafter, referred to as a PEEK composite material in some cases) can be widely used for various purposes in optical instruments such as cameras, electronic and electrical components, medical instruments, automobile components and the like due to the properties.

For example, polymer alloy containing PEEK and polyarylene sulfide has been proposed (for example, refer to Japanese Unexamined Patent Application, First Publication No. S58-160352). The polymer alloy containing PEEK and polyarylene sulfide has high fatigue strength and has been applied to bearings and a sliding portion for working machines and steering bearings.

In the related art, a large number of molded bodies formed from a PEEK composite material were coated and colored after molding. In recent years, in order to reduce manufacturing cost, a method in which the PEEK composite material is mixed with a pigment or a dye, and then the mixture is molded has been adopted.

### SUMMARY OF THE INVENTION

According to a first aspect of the present invention, there is provided a PEEK composite material including PEEK and polyolefin and having a single endothermic peak in a differential scanning calorimetry (hereinafter, abbreviated to DSC).

The PEEK and the polyolefin may have compatibility with each other. The composite material may have a matrix part formed from the PEEK and a first dispersed part dispersed in the matrix part, in which the first dispersed part may be formed from the polyolefin and may have a particle size of 1 μm or smaller. The composite material may have a matrix part formed from the PEEK and a second dispersed part dispersed in the matrix part, in which the second dispersed part may have the PEEK partially dispersed in the polyolefin and may have a particle size of 10 μm or smaller.

In addition, the present invention has the following aspects.

According to a second aspect of the present invention, a PEEK composite material may include PEEK and polyolefin, and have a single endothermic peak in a DSC.

According to a third aspect of the present invention, the PEEK and the polyolefin may have compatibility with each other in the second aspect.

According to a fourth aspect of the present invention, the PEEK composite material may have a matrix part formed from the PEEK and a first dispersed part dispersed in the matrix part, in which the first dispersed part may be formed from the polyolefin and may have a particle size of 1 μm or smaller in the second aspect

According to a fifth aspect of the present invention, the PEEK composite material may have a matrix part formed from the PEEK and a second dispersed part dispersed in the matrix part, in which the second dispersed part may be formed from the PEEK and the polyolefin. In the second dispersed part, the PEEK being partially dispersed in the polyolefin, and the second dispersed part may have a particle size of 10 μm or smaller.

### BRIEF DESCRIPTION OF THE DRAWINGS

FIG. 1 is a schematic view showing an example of a structure of a PEEK composite material according to the present invention.

FIG. 2 is a schematic view showing an example of a mixing device used in production of the PEEK composite material according to the present invention.

FIG. 3 is a graph showing a DSC measurement result in Example 1.

FIG. 4 is a graph showing a DSC measurement result in Example 5.

FIG. 5 is a graph showing a DSC measurement result in Comparative example 1.

### PREFERRED EMBODIMENTS

(PEEK Composite Material)

In one embodiment of the present invention, a PEEK composite material contains PEEK and polyolefin.

As a method of examining thermal properties of such a composite material in which two or more kinds of polymers are contained, a thermal analysis using a DSC has been known. In one embodiment of the present invention, the PEEK composite material has a single endothermic peak in a DSC (Differential Scanning Calorimetry). Since the PEEK composite material has a single endothermic peak, the molding temperature of the PEEK composite material can be efficiently decreased.

The endothermic peak refers to a temperature at which the amount of heat absorption is at a maximum in a DSC curve in which the vertical axis is set as heat flow and the horizontal axis is set as temperature. The shape of the endothermic peak in the DSC may be sharp or broad as long as there is a single endothermic peak.

In one embodiment of the present invention, the endothermic peak value of the PEEK composite material can be determined in accordance with the kind of pigment and dye added to the PEEK composite material, and for example, the value is preferably lower than 300° C., more preferably 280° C. or lower, and particularly preferably 250° C. or lower. When the value is the aforementioned upper limit or lower, the pigment or dye can be prevented from being discolored.

The lower limit of the endothermic peak is not particularly determined but is preferably, for example, 200° C. or higher, and more preferably 240° C. or higher. When the value is the aforementioned lower limit or higher, mechanical properties of the PEEK are not easily deteriorated.

Generally, since most composite materials containing two or more kinds of polymers do not have thermodynamically compatibility with each polymer in many cases, such composite materials may have nonuniform inner organization structures such as a sea-island structure, a sea-island-lake structure, and a composite structure thereof Generally, the “sea-island structure” refers to a structure in which one component (island component) is discontinuously dispersed in a granular shape in other component (sea component) that is relatively continuously observed when a material in which two or more kinds of polymers are mixed is observed by an electron microscope. Further, the “sea-island-lake structure” refers to a structure in which another component (lake component) is further discontinuously dispersed in a granular shape in the aforementioned island component. On the other hand, a structure in which the mixed polymers are homogeneously mixed and the aforementioned granular component is not observed is referred to as a “compatible structure”. Examples of the structure of the PEEK composite material according to the embodiment of the present invention include a structure in which the PEEK and the polyolefin have compatibility with each other (compatible structure) and a sea-island structure in which first dispersed parts (island components) formed from the polyolefin are dispersed in a matrix part (sea component) formed from the PEEK.

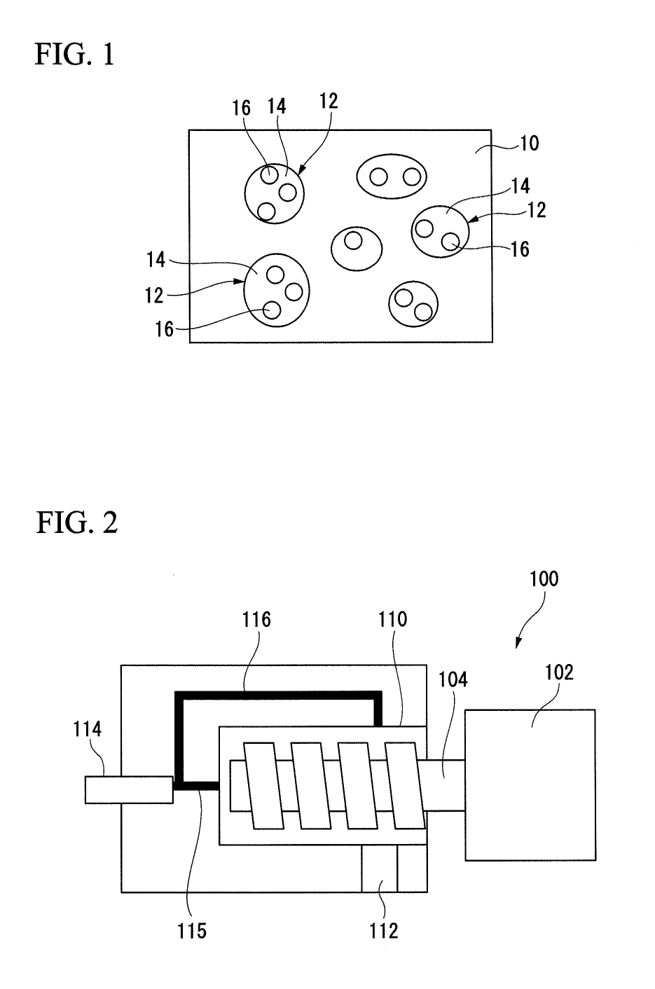

For example, as shown in FIG. 1, a structure (sea-island-lake structure), in which a matrix part 10 (sea component) formed from the PEEK and a second dispersed part 12 (island and lake components) may be adopted. The second dispersed part 12, which is dispersed in the matrix part 10, has a PEEK 16 (dispersion PEEK which is a lake component) dispersed in a polyolefin 14 (island and lake components).

Alternatively, a structure in which two or more kinds selected from a compatible structure, a sea-island structure and a sea-island-lake structure are mixed may be adopted.

Among the aforementioned structures, a compatible structure is preferable. When the compatible structure is adopted, the effect of the present invention is easily exhibited.

In one embodiment of the present invention, the compatible structure refers to a structure in which the particle of the PEEK or the polyolefin having a particle size of 1 nm or larger cannot be observed in the PEEK composite material. When the compatible structure is adopted, the particles of the PEEK and the polyolefin can be observed using a scanning electron microscope (SEM) or a transmission electron microscope (TEM).

When the PEEK composite material has the sea-island structure, the particle size of the first dispersed part is 1 μm or smaller.

When the particle size of the first dispersed part is the aforementioned upper limit or smaller, that is, 1 μm or smaller, a molding temperature can be more efficiently decreased.

The particle size is a value measured using a SEM or TEM. Further, the particle size indicates a length of the longest straight line that can be drawn in an observed particle region. In addition, it is only necessary to satisfy the limitation of the particle size by an average value of the particle size.

The content of the first dispersed part in the PEEK composite material is not particularly limited.

When the PEEK composite material has the sea-island-lake structure, the particle size of the second dispersed part 12 is 10 μm or smaller. When the particle size of the second dispersed part 12 is the aforementioned upper limit or smaller, that is, 10 μm or smaller, the molding temperature can be more efficiently decreased.

The content of the second dispersed part 12 in the PEEK composite material is not particularly limited.

That is, in order for the composite material to have a single endothermic peak in the DSC, for example, it is only necessary to satisfy any one of the following conditions: (1) a state in which the particle of the PEEK or the polyolefin having the particle size of 1 nm or larger cannot be observed in the PEEK composite material, that is, the composite material has a compatible structure, (2) when the PEEK composite material has a sea-island structure, the particle size of the first dispersed part is 1 μm or smaller, and (3) when the PEEK composite material has a sea-island-lake structure, the particle size of the second dispersed part is 10 μm or smaller.

The particle size of the dispersion PEEK 16 in the second dispersed part 12 is not particularly limited.

The content of the dispersion PEEK 16 in the second dispersed part 12 is not particularly limited.

<PEEK>

The PEEK of one embodiment of the present invention can be selected in accordance with applications of the PEEK composite material, and examples thereof include a PEEK resin, VESTAKEEP 2000G, manufactured by Daicel-Evonik Ltd.

In one embodiment of the present invention, the content of the PEEK in the PEEK composite material can be determined in accordance with properties required for the PEEK composite material such as mechanical property, and is preferably 10% by mass to 90% by mass. When the content of the PEEK is the aforementioned lower limit or higher, that is, 10% by mass or higher, the mechanical property of the PEEK can be effectively exerted. When the content is the aforementioned upper limit or lower, that is, 90% by mass or lower, the molding temperature is easily decreased.

<Polyolefin>

The polyolefin of one embodiment of the present invention can be selected in accordance with the molding temperature and physical properties required for the PEEK composite material, and examples thereof include known polyolefins like polyethylenes (PE) such as low-density polyethylene and high-density polyethylene, and polypropylenes (PP).

In one embodiment of the present invention, the content of the polyolefin in the PEEK composite material can be determined in accordance with properties required for the PEEK composite material such as mechanical property, and is preferably 10% by mass to 90% by mass.

In one embodiment of the present invention, the PEEK composite material may contain resins (arbitrary resins) other than the PEEK and polyolefin.

Examples of the arbitrary resins include polyphenylenesulfide and polyaryl ketone other than PEEK.

In one embodiment of the present invention, the content of the arbitrary resins in the PEEK composite material can be determined in accordance with properties required for the PEEK composite material.

(Production Method)

Examples of the method of producing the PEEK composite material of one embodiment of the present invention include a method of kneading PEEK pellets and polyolefin pellets (kneading process).

In the kneading process, known kneading apparatuses can be used. Examples of the kneading apparatus include a mixing apparatus 100 shown in FIG. 2.

The mixing apparatus 100 includes a mixing unit 110 and a mixing impeller 104 provided in the mixing unit 110.

The mixing impeller 104 is a helical screw, and is connected to a driving unit 102. The mixing unit 110 is connected to an inlet 112 and connected to an outlet 114 through a pipe 115. Further, the mixing unit 110 is connected to the pipe 115 by a circulation path 116.

In the method of producing the PEEK composite material using the mixing apparatus 100, PEEK pellets and polyolefin pellets (hereinafter, collectively referred to as a raw material pellet in some cases) are kneaded in the mixing unit 110.

First, the raw material pellet is supplied to the mixing unit 110 from the inlet 112. The mixing impeller 104 is rotated by driving the driving unit 102 and while the supplied raw material pellet is being kneaded, a kneaded PEEK composite material is discharged from the outlet 114 through the pipe 115. At this time, the PEEK composite material can have an arbitrary structure by adjusting the rotation rate of the mixing impeller 104.

The temperature during the kneading can be determined in accordance with the kind of the PEEK or the polyolefin.

Alternatively, the outlet 114 may be closed to knead the raw material pellet and the mixture may be returned to the mixing unit 110 through the circulation path 116. The mixture returned to the mixing unit 110 is further kneaded by the mixing impeller 104. The mixture is circulated an arbitrary number of times, and then, the outlet 114 is opened to discharge the PEEK composite material. At this time, the PEEK composite material can be made to have an arbitrary structure by adjusting the number of circulation of the mixture.

Further, as necessary, the PEEK composite material discharged from the mixing apparatus 100 may be formed in a pellet shape using a common method.

(Molded Body)

A molded body of one embodiment of the present invention contains the PEEK composite material of the present invention, and is obtained, for example, by mixing pellets of the PEEK composite material and a colorant, melting the mixture, and subjecting the molten mixture to injection molding.

Examples of the colorant used in the molded body include organic pigments such as phthalocyanine, anthraquinone, isoindolinone, quinacridone, perylene and azo pigments, and inorganic pigments such as carbon black, cobalt blue and titanic oxide pigments. Among them, organic pigments are preferable. In the molded body using such a colorant, discoloration of the colorant by heat when the PEEK composite material is melted and molded is suppressed and the effect of the present invention is remarkably exhibited.

Since the PEEK composite material of one embodiment of the present invention contains the PEEK and the polyolefin, and has the single endothermic peak in a DSC, this means that each of the PEEK and the polyolefin loses thermal properties and gains new thermal properties. The new thermal properties are intermediate properties between thermal properties of the PEEK and thermal properties of the polyolefin, and therefore, the PEEK composite material of the present invention has a lower melting point than that of the PEEK. As a result, since the PEEK composite material of the present invention can be melted at a lower temperature than PEEK composite materials in the related art, the molding temperature can be decreased.

Therefore, the colorant which is easily discolored at the molding temperature of the PEEK composite materials in the related art can be used in the present invention. As a result, it is possible to impart various colors to the molded body.

### EXAMPLES

Hereinafter, the present invention will be described in detail with reference to examples, but the present invention is not limited to the following description.

### Examples 1 to 7, Comparative Examples 1 and 2

According to production conditions shown in Table 1, 50% by mass of PEEK (VESTAKEEP 2000G, endothermic peak: 340° C., manufactured by Daicel-Evonik Ltd.) and 50% by mass of PP (NOVATEC-PP MA1B, endothermic peak: 160° C., manufactured by Japan Polypropylene Corporation) were kneaded using the mixing apparatus 100 shown in FIG. 1 to prepare PEEK composite materials in each example.

The endothermic peaks, structures and particle sizes of first and second dispersed parts of the obtained PEEK composite materials (hereinafter, collectively referred to as dispersed part sizes in some cases) were evaluated. The results are shown in Table 1.

(Evaluation Method)

<Endothermic Peak>

Using a thermal analysis apparatus (manufactured by Rigaku Corporation), the PEEK composite materials in each example were heated to 350° C. from 25° C. at a temperature rise rate of 10° C./min to obtain DSC curves. The endothermic peaks were attained from the obtained DSC curves.

<Structure and Dispersed Part Size>

The structure and the dispersed part size of each examples of the PEEK composite material were identified by observing the sample at TEM (manufactured by JEOL Ltd., magnification: 200 to 250,000 times).

TABLE 1

| | | | | Production conditions | | | Properties | | |
|---|---|---|---|---|---|---|---|---|---|
| | | Composition | | | Rotation | | Endothermic | | |
| | | (% by mass) | | Temperature | rate | Time | peak | | Dispersed |
| | | PEEK | PP | (° C.) | (rpm) | (sec.) | (° C.) | Structure | part size |
| Examples | 1 | 50 | 50 | 295 | 1750 | 25 | 250 | Compatible | <1 nm |
| | 2 | 50 | 50 | 295 | 850 | 25 | 235~275 | Sea-island | 0.7~1 |
| | | | | | | | | | μm |
| | 3 | 50 | 50 | 295 | 1250 | 25 | 245~265 | Sea-island | 100~200 |
| | | | | | | | | | nm |
| | 4 | 50 | 50 | 295 | 1500 | 25 | 250 | Sea-island | 1~50 |
| | | | | | | | | | nm |
| | 5 | 50 | 50 | 310 | 500 | 15 | 210~295 | Sea-island- | 1~10 |
| | | | | | | | | lake | μm |
| | 6 | 50 | 50 | 310 | 1500 | 15 | 245~265 | Sea-island- | 100~200 |
| | | | | | | | | lake | nm |
| | 7 | 50 | 50 | 310 | 2000 | 15 | 250 | Sea-island- | 1~50 |
| | | | | | | | | lake | nm |
| Comparative | 1 | 50 | 50 | 295 | 50 | 25 | 170/330 | Sea-island | 2~5 |
| examples | | | | | | | | | μm |
| | 2 | 50 | 50 | 310 | 50 | 15 | 170/330 | Sea-island- | 20 μm |
| | | | | | | | | lake | |

As shown in Table 1, Examples 1 to 7 to which the present invention was applied had a single endothermic peak in the DSC. Further, all of the PEEK composite materials in Examples 1 to 7 had a lower endothermic peak than the PEEK used as the raw material. That is, it was determined that Examples 1 to 7 were able to be molded at a lower temperature than the PEEK which is an ingredient.

In addition, from the results of Examples 1 to 7, it was determined that the smaller the dispersed part sizes, the sharper the endothermic peak, and the composite material were able to be molded at a lower temperature.

On the other hand, Comparative examples 1 and 2 had two endothermic peaks (170° C. and 330° C.). Therefore, it was determined that the molding temperature of the PEEK composite materials in Comparative examples 1 and 2 was approximately the same as the molding temperature of the PEEK which is the raw material.

From the results, it was determined that the molding temperature of the PEEK composite material was able to be decreased by application of the present invention and a molded body was able to be obtained without discoloration of the colorant added during molding. Therefore, the molded body using the PEEK composite material is possible to have variety of colors.

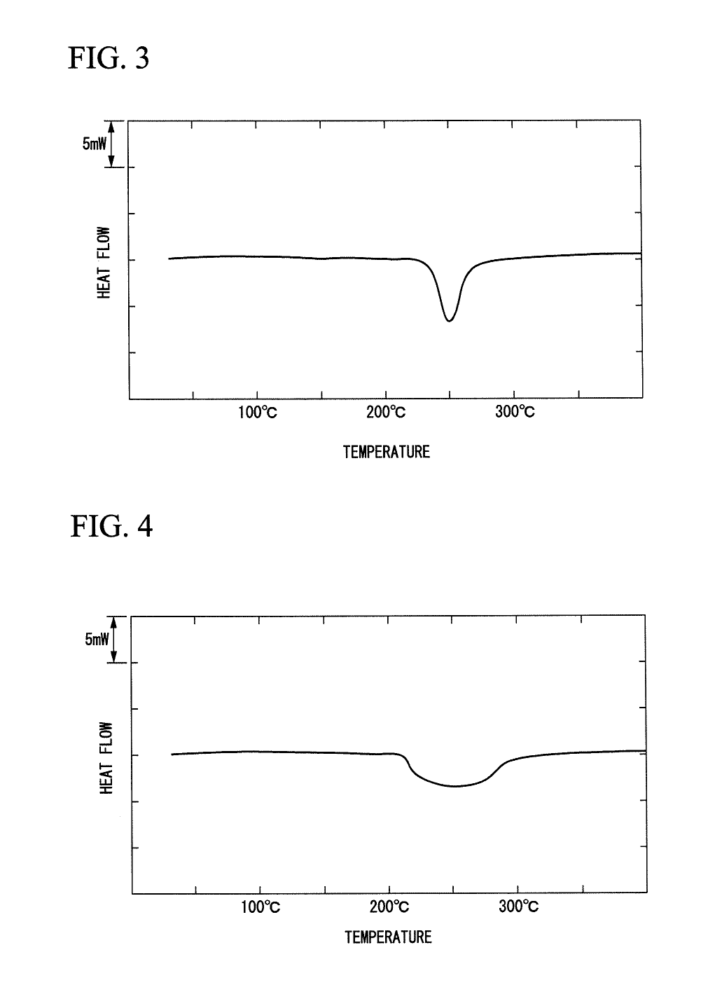

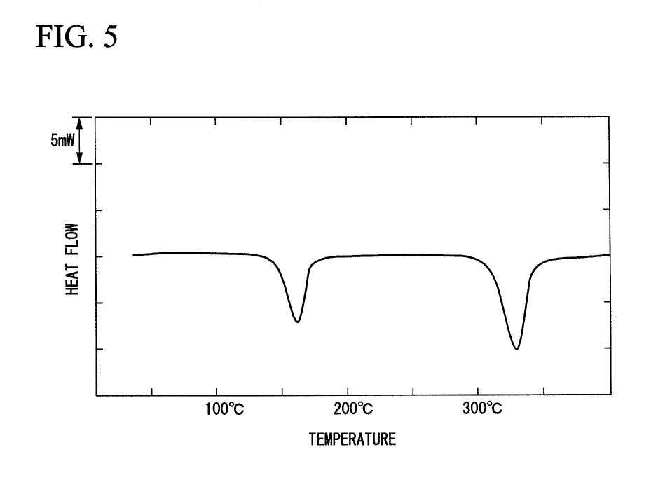

DSC curves of Examples 1 and 5, and Comparative example 1 are shown in FIG. 3 to FIG. 5. FIG. 3 is a graph showing a DSC measurement result of the PEEK composite material in Example 1. FIG. 4 is a graph showing a DSC measurement result of the PEEK composite material in Example 5. FIG. 5 is a graph showing a DSC measurement result of the PEEK composite material in Comparative example 1. In all FIG. 3 to FIG. 5, the vertical axis represents heat flow (mW) and the horizontal axis represents temperature (° C.).

In view of FIG. 3 to FIG. 4, it was determined that all of Examples 1 and 5, to which the present invention was applied, had a single endothermic peak shown in the DSC. Further, from FIGS. 3 and 4, it was determined that Example 1 in which the dispersed part size was smaller than 1 nm had a sharper endothermic peak than Example 5 in which the dispersed part size was 1 μm to 10 μm.

On the other hand, as shown in FIG. 5, Comparative example 1 had two endothermic peaks in the DSC.

The preferred embodiments of the present invention have been described above, but the present invention is not limited to these embodiments. Additions, omissions, substitutions, and other modifications can be made within a range which does not depart from the spirit of the present invention. The present invention is not limited by the aforementioned description and is only limited by the scope of the appended claims.

### REFERENCE SIGNS LIST

10 Matrix part

12 Second dispersed part

14 Polyolefin

16 Dispersion PEEK

1. A polyether ether ketone composite material comprising:
polyether ether ketone and
polyolefin,
wherein the composite material has a single endothermic peak in a Differential Scanning Calorimetry.

2. The polyether ether ketone composite material according to claim 1,
wherein the polyether ether ketone and the polyolefin have compatibility with each other.

3. The polyether ether ketone composite material according to claim 1, wherein the polyether ether ketone composite material has a matrix part formed from the polyether ether ketone and a first dispersed part dispersed in the matrix part,
wherein the first dispersed part is formed from the polyolefin and has a particle size of 1 μm or smaller.

4. The polyether ether ketone composite material according to claim 1, wherein the polyether ether ketone composite material has a matrix part formed from t the polyether ether ketone and a second dispersed part dispersed in the matrix part,
wherein the second dispersed part is formed from the polyether ether ketone and the polyolefin, the polyether ether ketone being partially dispersed in the polyolefin, and the second dispersed part has a particle size of 10 μm or smaller.
